(19) United States
(12) Patent Application Publication
(10) Pub. No.: US 2025/0001403 A1
(43) Pub. Date: Jan. 2, 2025

(54) CATALYST, CATALYST SYNTHESIS METHOD AND CATALYTIC PLASTIC CONVERSION METHOD

(71) Applicant: Agency for Science, Technology and Research, Singapore (SG)

(72) Inventors: Lili ZHANG, Jurong Island (SG); Wei Jie YAP, Jurong Island (SG); Li Ying Jennet ONG, Jurong Island (SG)

(21) Appl. No.: 18/709,174

(22) PCT Filed: Oct. 21, 2022
(86) PCT No.: PCT/SG2022/050754

§ 371 Date: May 10, 2024

(30) Foreign Application Priority Data
Nov. 10, 2021 (SG) 10202112467Y

(51) Int. Cl. B01J 23/745; B01J 6/00; B01J 21/04; B01J 21/08; B01J 21/10; B01J 23/755; B01J 37/02; B01J 37/04; B01J 37/08

(52) U.S. Cl. CPC B01J 23/745; B01J 6/001; B01J 21/04; B01J 21/08; B01J 21/10; B01J 23/755; B01J 37/0209; B01J 37/0213; B01J 37/04; B01J 37/08

(57) ABSTRACT

A catalyst, a catalyst synthesis method (10) and a catalytic plastic conversion method (50) are provided. The catalyst includes a single metal oxide on a catalyst support. The catalyst synthesis method (10) includes dissolving (12) a single metal precursor in deionised water to form a precursor-containing solution, mixing (14) a catalyst support into the precursor-containing solution to impregnate the catalyst support with the precursor-containing solution, drying (18) the impregnated catalyst support, and calcining (20) the dried impregnated catalyst support to form a supported single metal oxide catalyst.

### FIELD OF THE INVENTION

The present invention relates in general to waste plastic conversion and more particularly to a catalyst for waste plastic conversion, a method of synthesising the catalyst, and a catalytic plastic conversion method using the synthesised catalyst.

### BACKGROUND OF THE INVENTION

Plastic pollution has become one of the most pressing environmental issues globally. Existing widely used plastics are difficult to degrade. Incineration and landfill are currently the most common practices for plastic waste disposal. However, both have shortcomings such as, for example, generation of large quantities of carbon dioxide (CO₂), secondary pollution and release of toxins into the environment (for example, to air, ground water, etc). Ashes from incineration may also need to be landfilled. Land available for landfill is however limited and decreasing, especially for small countries like Singapore. Mechanical recycling is limited in having to treat mixed and dirty plastic waste, and products of mechanical recycling typically have deteriorated properties (i.e., down cycling). Efforts have also been made to pyrolyse waste plastic to produce fuels or pyrolysis oils. Conversion into fuels is however not economical or circular as CO₂ is produced again. Pyrolysis oils are often low grade and low value, requiring further upgrading. Oftentimes, low profit margin from pyrolysis makes the whole process unattractive. Therefore, there is increasing demand and interest to provide an economically viable and energy efficient option to upcycle waste plastic to significantly higher value products.

### SUMMARY OF THE INVENTION

Accordingly, in a first aspect, the present invention provides a catalyst. The catalyst includes a single metal oxide on a catalyst support.

In a second aspect, the present invention provides a catalyst synthesis method. The catalyst synthesis method includes dissolving a single metal precursor in deionised water to form a precursor-containing solution; mixing a catalyst support into the precursor-containing solution to impregnate the catalyst support with the precursor-containing solution; drying the impregnated catalyst support; and calcining the dried impregnated catalyst support to form a supported single metal oxide catalyst.

In a third aspect, the present invention provides a catalytic plastic conversion method. The catalytic plastic conversion method includes: providing the catalyst in accordance with the first aspect; providing a quantity of plastic; and performing catalytic-pyrolysis of the plastic using the catalyst.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic flow diagram illustrating a catalyst synthesis method in accordance with an embodiment of the present invention;

FIG. 2 is a schematic flow diagram illustrating a catalytic plastic conversion method in accordance with embodiments of the present invention;

FIGS. 3A and 3B are scanning electron microscopy (SEM) images of carbon nanotubes (CNTs) derived from waste plastic using the catalytic plastic conversion method of FIG. 2;

FIG. 4 is a graph of Raman spectra of the CNTs derived from waste plastic using the catalytic plastic conversion method of FIG. 2 and commercial CNTs; and

FIG. 5 is a graph of results of thermal gravimetric analysis (TGA) performed on the CNTs derived from waste plastic using the catalytic plastic conversion method of FIG. 2.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “single metal oxide” as used herein refers to a metal oxide having atoms of only one (1) type of metal element.

The term “secondary metal oxide” as used herein refers to a metal oxide having atoms of a second metal element.

The term “precursor” as used herein refers to a substance from which another is formed. Accordingly, the term “single metal precursor” as used herein refers to a substance having atoms of one (1) type of metal element from which another substance is formed and the term “secondary metal precursor” as used herein refers to a substance having atoms of a second metal element from which another substance is formed.

The term “precursor-containing solution” as used herein refers to a liquid mixture into which a precursor is dissolved.

The term “trace amount” as used herein refers to a very small quantity of a substance, usually less than 1 percent by mass (wt %).

The term “molar ratio” as used herein refers to a ratio between molar concentrations of two substances.

The term “catalyst support” as used herein refers to a material, usually a solid with a high surface area, to which a catalyst is affixed.

The term “supported single metal oxide catalyst” as used herein refers to a catalyst having atoms of substantially only one (1) type of metal element supported on a catalyst support.

The term “calcining” as used herein refers to heating a solid to a high temperature to remove volatile substances and oxidize a portion of the solid in air.

The term “catalytic-pyrolysis” as used herein refers to thermal decomposition of a material at an elevated temperature in an inert atmosphere in the presence of a catalyst.

The term “ambient pressure” as used herein refers to atmospheric pressure.

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

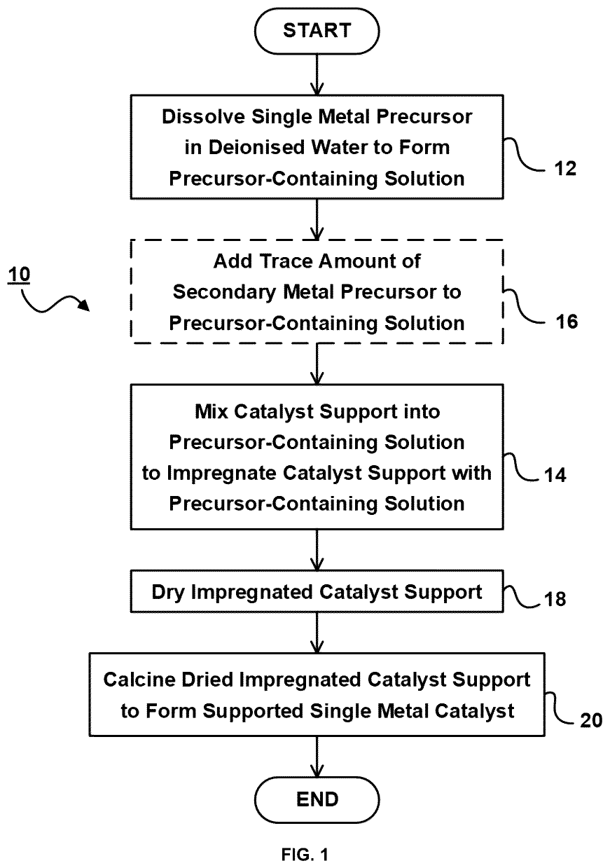

Referring now to FIG. 1, a catalyst synthesis method 10 is shown. The catalyst synthesis method 10 begins at step 12 by dissolving a single metal precursor in deionised water to form a precursor-containing solution. The single metal precursor may be one of iron (III) nitrate nonahydrate, iron chloride, iron carbonate, iron acetate, nickel chloride, nickel carbonate, nickel acetate and nickel (II) nitrate hexahydrate.

At step 14, a catalyst support is mixed into the precursor-containing solution to impregnate the catalyst support with the precursor-containing solution. Actual testing condition such as, for example, if the catalyst has to be used in a fluidized bed reactor, may be taken into account during design and synthesis of the catalyst to ensure selection of the catalyst support is suitable for an actual condition. The catalyst support may be one of alumina (Al₂O₃), silica (SiO₂) and Al₂O₃MgO.

A trace amount of a secondary metal precursor may be added at step 16 to the precursor-containing solution before mixing the catalyst support into the precursor-containing solution at step 14. The secondary metal precursor may be one of nickel (II) nitrate hexahydrate, nickel chloride, nickel carbonate and nickel acetate. A molar ratio of metal content in the single metal precursor to the secondary metal precursor may be between about 50 and about 1050. In one or more embodiments, the molar ratio of the metal content in the single metal precursor to the secondary metal precursor may be between about 105 and about 210.

At step 18, the impregnated catalyst support is dried.

The dried impregnated catalyst support is calcined at step 20 to form a supported single metal oxide catalyst. The dried impregnated catalyst support may be calcined at a temperature of between about 200 degrees Celsius (° C.) and about 800° C. In one or more embodiments, the dried impregnated catalyst support is calcined at 500° C.

The catalyst synthesis method 10 may be used to develop single metal oxide catalysts on different supports (i.e. Fe/Al₂O₃, Fe/SiO₂, Fe/Al₂O₃MgO) with different metal loadings and/or with the presence of a trace amount of other metal (i.e. Ni, with Fe/Ni ratio from 50 to 1050, more particularly, 105 to 210). A cost-effective single metal oxide catalyst with Fe loading ranging from 10-15 wt % may be produced using the catalyst synthesis method 10.

Having described the catalyst synthesis method 10, a catalyst thus formed will next be described. The catalyst includes a single metal oxide on a catalyst support. The catalyst support may be one of alumina (Al₂O₃), silica (SiO₂) and Al₂O₃MgO and may be loaded with between about 5 percent by weight (wt %) and about 15 wt % of the single metal oxide. The single metal oxide may be automatically reduced to metal during a catalytic-pyrolysis process.

The catalyst may include a trace amount of a secondary metal oxide on the catalyst support. The secondary metal oxide may form metal clusters with the single metal oxide. In other words, the catalyst may include a single atom metal or metal cluster, that is, a single metal oxide with trace co-metal cluster, for better catalytic activity and selectivity. Single metal oxide and co-metal cluster concept allows achievement of much better performance with much less metal loadings at lower cost, achieving highest efficiency among few reports that are with more expensive catalyst or process. A molar ratio of the single metal oxide to the secondary metal oxide may be between about 50 and about 1050. In one or more embodiments, the molar ratio of the single metal oxide to the secondary metal oxide may be between about 105 and about 210.

Having described the catalyst, use of the catalyst in a catalytic plastic conversion method will now be described.

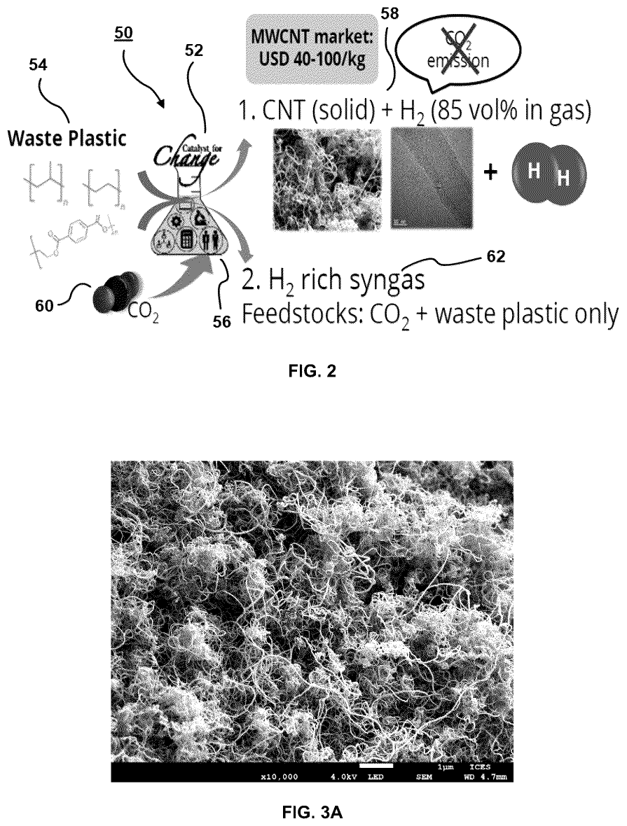

Referring now to FIG. 2, a catalytic plastic conversion method 50 is shown. The catalytic plastic conversion method 50 begins at step 52 by providing the catalyst. No pre-reduction or prior treatment of the catalyst is required and thus, no H₂ is needed for the process 50 to take place.

At step 54, a quantity of plastic is provided. The plastic may include one or more of polyethylene (PE), polyethylene terephthalate (PET), polystyrene (PS), household plastic waste and polypropylene (PP). Advantageously, the catalytic plastic conversion method 50 has high tolerance level to contaminated mixed waste plastic that are extremely difficult to treat by other methods and there is flexibility in the feedstock (C, H, O) that may be used in the catalytic plastic conversion method 50.

Catalytic-pyrolysis of the plastic is performed using the catalyst at step 56. Catalytic-pyrolysis of the plastic may be performed at a temperature of less than 700° C. In one or more embodiments, the temperature at which catalytic-pyrolysis of the plastic is performed may be between about 450° C. and about 600° C. Catalytic-pyrolysis of the plastic may be performed at a ramp rate of between about 30 degrees Celsius per minute (° C./min) and about 60° C./min. Catalytic-pyrolysis of the plastic may be performed at ambient pressure. Catalytic-pyrolysis of the plastic may be performed for a period of between about 5 min and about 10 min. Advantageously, the catalytic plastic conversion method 50 may be used to produce high quality carbon nanotubes (CNTs) from waste plastic at low process temperature T (about 700° C.) at ambient pressure P.

The catalyst may be reduced before performing catalytic-pyrolysis of the plastic using the reduced catalyst. The catalyst may be reduced at a temperature of between about 600° C. and about 800° C. The catalyst may be reduced for a period of between about 10 minutes (min) and about 30 min.

A plurality of carbon nanotubes may be generated at step 58 from catalytic-pyrolysis of the plastic. Advantageously, the catalytic plastic conversion method 50 eliminates the use of H₂ for CNT production. A yield of the carbon nanotubes from catalytic-pyrolysis of the plastic may be between about 28 percent by mass (wt %) and about 84 wt % of carbon content in the plastic. In one or more embodiments, the yield of the carbon nanotubes from catalytic-pyrolysis of the plastic may be between about 70 wt % and about 75 wt % of carbon content in the plastic. At step 58, hydrogen gas may also be generated from catalytic-pyrolysis of the plastic. The hydrogen gas may comprise between about 77 percent by volume (vol %) and about 88 vol % of a gas stream from catalytic-pyrolysis of the plastic. Methane gas may also be generated from catalytic-pyrolysis of the plastic. The methane gas may comprise between about 6 vol % and about 18 vol % of the gas stream from catalytic-pyrolysis of the plastic. Advantageously, the catalytic plastic conversion method 50 provides carbon credit (vs incineration) and high value products (vs pyrolysis) such as, for example, MWCNT at USD 40-100/kg and USD100,000/Ton and another valuable by-product in the form of H₂.

Carbon dioxide (CO₂) may be introduced at step 60 when the plastic starts to decompose.

At step 62, synthesis gas may be generated from CO₂ reforming of the plastic. The synthesis gas may comprise between about 27 vol % and about 85 vol % of hydrogen gas. In one or more embodiments, the synthesis gas may comprise between about 80 vol % and about 85 vol % of hydrogen gas. The synthesis gas may comprise between about 10 vol % and about 18 vol % of carbon monoxide gas. In one or more embodiments, the synthesis gas may comprise between about 10 vol % and about 15 vol % of carbon monoxide gas. Advantageously, syngas may be obtained from CO₂ and waste plastic via the catalytic plastic conversion method 50.

Thermal catalytic processes to convert waste plastic are described and two (2) different catalytic pathways are shown in FIG. 2. Advantageously, the convertible process design allows evaluation of completely different processes for different targeted products. Further advantageously, the catalytic plastic conversion method 50 is highly tolerant to contaminated waste plastic that are not treatable by other methods with similar carbon footprint.

In the first process where waste plastic is catalytically converted into CNTs and H₂, the carbon recovery is as high as 75 wt %, which is one of the highest among the few reported (which use more expensive catalysts and/or with high energy form). The gas stream contains about 85 vol % H₂ and 12-15 vol % of CH₄. The high percentage of H₂ in the gas stream makes it possible for use as a clean fuel.

In the second process where waste plastic is CO₂-reformed with a single iron oxide-based catalyst into H₂-enriched syngas, the gas products contain H₂ in the range of 75-85 vol % and CO in the range of 10-17 vol % with little coking of the catalyst during the entire time-on-stream. The results are much better than literature reports on NiCo based bi-metal oxide catalysts.

The catalytic plastic conversion method 50 may be used to obtain functional carbon and syngas (100% recycled content in the end product) through direct conversion of plastic waste with no direct carbon dioxide (CO₂) emission.

### Catalyst Synthesis

Supported iron catalysts are prepared by wet impregnation method with 5-15 wt % of iron (Fe) loaded on various supports such as, for example, Al₂O₃, SiO₂ and Al₂O₃MgO. Iron (III) nitrate nonahydrate is fully dissolved in deionised (DI) water. The single metal precursor may be extended to other precursors such as chlorides, carbonates, acetates. Trace amount of nickel (II) nitrate hexahydrate with a Fe/Ni molar ratio of between about 50 and about 1050, more particularly, between about 105 and about 210, is added to the solution. The secondary metal precursor may be extended to other precursors such as chlorides, carbonates, acetates. A support such as, for example, alumina, silica or Al₂O₃MgO, is then added in and stirred at 80° C. with constant stirring until clay-like. The clay-like products are then dried at 120° C. in an oven. Final products are obtained after the crushed samples are calcined at a temperature of between about 200 degrees Celsius (° C.) and about 800° C., preferably 500° C.

### Experimental Results

Performances of the catalysts produced in accordance with the catalyst synthesis method 10 in catalytic conversion of waste plastic to high quality CNTs and to H₂-enriched syngas was investigated with consideration of life cycle analysis and scalability of the process.

In a catalytic conversion of plastic waste to carbon nanotubes (CNT) process, the catalyst may be used as is without further treatment. In alternative embodiments, the catalyst may be firstly reduced at temperatures ranging from 600° C.-800° C., more preferably 700° C.-800° C., for 10-30 mins. Pyrolysis of waste plastic was then performed at a temperature from 450° C.-600° C. with fast ramping at 30° C./min to 60° C./min. The CNT growth began when the waste plastic started to decompose at 450° C. and the reaction took about 5-10 mins in total. Gaseous products were monitored using online-mass spectrometry (MS) and analysed with online-gas chromatography (GC), while solid products were collected at the end of the process (any liquid products will be condensed in a condenser). A summary of the preliminary results using different types of catalysts is shown in Table 1 below.

TABLE 1
Performance of the catalysts in catalytic conversion of waste plastic to CNTs and H₂

| | | Plastic | | | | | | |
|---|---|---|---|---|---|---|---|---|
| | | (PE or | | | | | | C |
| | cat | PS) | H₂ | CH₄ | CO | C₂—C₄ | CNT | Recovery |
| Catalyst | g | g | vol % | vol % | vol % | vol % | mg | % |
| 15 wt % | 0.5 | PE: 1 | 84.31% | 15.60% | 0.00% | 0.09% | 504.1 | 68% |
| FeNi_{trace}/Al₂O₃MgO | | | | | | | | |
| (Fe/Ni = 105) | | | | | | | | |
| 15 wt % | 0.5 | PE: 1 | 85.10% | 12.06% | 0.21% | 2.63% | 456.7 | 69% |
| FeNi_{trace}/Al₂O₃ | | | | | | | | |
| (Fe/Ni = 105) | | | | | | | | |
| 15 wt % | 0.5 | PE: 1 | 85.86% | 6.01% | 0.28% | 7.85% | 402.1 | 55% |
| FeNi_{trace}/SiO₂ | | | | | | | | |
| (Fe/Ni = 105) | | | | | | | | |
| 15 wt % | 0.5 | PE: 2 | 81.16% | 17.90% | 0.15% | 0.79% | 1210.9 | 76% |
| FeNi_{trace}/Al₂O₃MgO | | | | | | | | |
| (Fe/Ni = 105) | | | | | | | | |
| 15 wt % | 0.5 | PE: 3 | 85.66% | 11.6% | 0.09% | 2.65% | 1427.5 | 67% |
| FeNi_{trace}/Al₂O₃MgO | | | | | | | | |
| (Fe/Ni = 105) | | | | | | | | |
| 15 wt % | 0.5 | PS: 1 | 89.31% | 8.55% | 2.14% | 0.00% | 767.3 | 83.7% |
| FeNi_{trace}/Al₂O₃MgO | | | | | | | | |
| (Fe/Ni = 105) | | | | | | | | |
| 15 wt % | 0.5 | PE: 1 | 84.29% | 12.46% | 0.17% | 3.08% | 460.3 | 67% |
| FeNi_{trace}/Al₂O₃ | | | | | | | | |
| (Fe/Ni = 210) | | | | | | | | |
| 15 wt % | 0.5 | PE: 1 | 80.73% | 15.94% | 0.19% | 3.14% | 535 | 69% |
| FeNi_{trace}/Al₂O₃MgO | | | | | | | | |
| (Fe/Ni = 210) | | | | | | | | |
| 10 wt % | 0.5 | PE: 1 | 87.12% | 10.34% | 0.11% | 2.43% | 411 | 65% |
| FeNi_{trace}/Al₂O₃MgO | | | | | | | | |
| (Fe/Ni = 105) | | | | | | | | |
| 10 wt % | 0.5 | PE: 1 | 77.79% | 10.52% | 0.05% | 11.64% | 428.2 | 61% |
| FeNi_{trace}/Al₂O₃ | | | | | | | | |
| (Fe/Ni = 105) | | | | | | | | |
| 15 wt % Fe/Al₂O₃ | 0.5 | PE: 1 | — | — | — | — | 322 | 40% |
| 15 wt % Ni/Al₂O₃ | 0.5 | PE: 1 | — | — | — | — | 229 | 28% |
| 40 wt % FeAlOx^{Ref1} | 0.5 | PE: 1 | 66% | 15% | 0.21% | 19% | 287 | 38% |

^{Ref1}Catalyst from Nat Catal 3, 902-912 (2020)

As can be seen from Table 1 above, the new catalysts developed achieved one of the highest carbon recovery and H₂ yield from waste plastic among the few reported papers, which require either more energy intensive methods or more expensive catalysts. Preliminary results showed that carbon recovery (in the form of CNTs) from waste plastic is at about 70-84 wt % with the gas stream containing mainly H₂ (approximately 85 vol %) and CH₄ (approximately 15 vol %) when polyolefin-enriched waste plastic is used as the feedstock (i.e., PE). Moreover, with 0.5 g of catalyst (i.e., FeNi_{trace}/Al₂O₃MgO or FeNi_{trace}/Al₂O₃), approximately 1.4 g of CNT (i.e., 2.8 g CNT/g cat) can be produced from waste plastic at a reaction temperature of 700° C. within 5-10 mins. The results are much better than previous disclosure on conversion of waste plastic to solid carbon, but with catalysts having much higher metal loading and/or with much more energy intensive method.

The CNTs derived from waste plastic were characterized by scanning electron microscopy (SEM), Raman and thermogravimetric analysis (TGA).

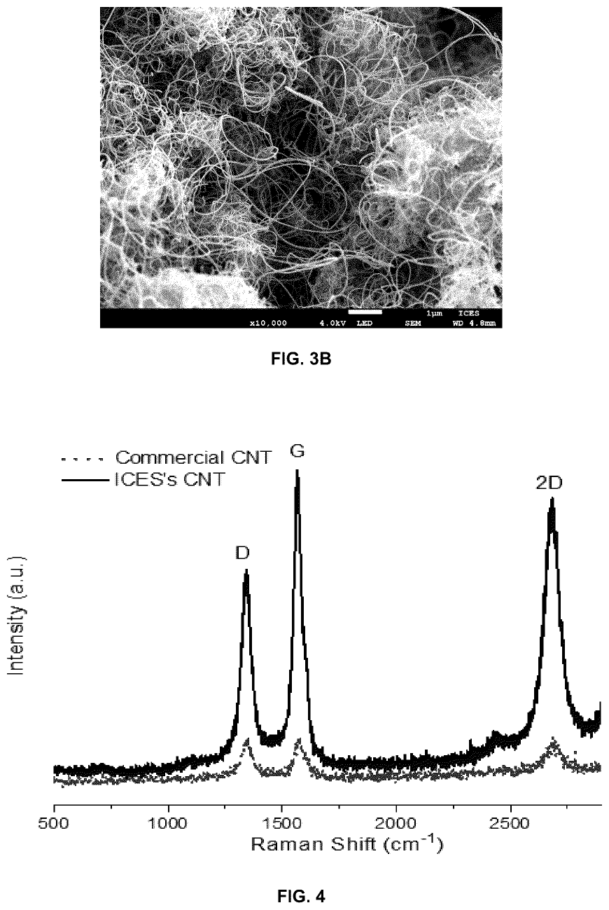

Referring now to FIGS. 3A and 3B, long CNTs with diameters of about 10-30 nanometres (nm) were seen under SEM.

Referring now to FIG. 4, Raman spectra were collected using 532 nm laser excitation. In comparison to commercial CNTs (Timesnano MWCNTs, 98% purity, price at $1,000/kg), the CNTs derived from waste plastic using the catalytic plastic conversion method 50 show much higher G band, G/D ratio, as well as 2D or G′ band, indicating much better graphitization of the CNTs derived from waste plastic. As can be seen from FIG. 4, quality of the CNTs obtained from the catalytic plastic conversion method 50 is comparable to or even better than mid-grade commercially available MWCNTs (Timesnano MWCNTs, 98% purity, price at $1000/kg). Advantageously, this facilitates a move away from fossil fuel-dependent feedstock for production of high quality CNTs.

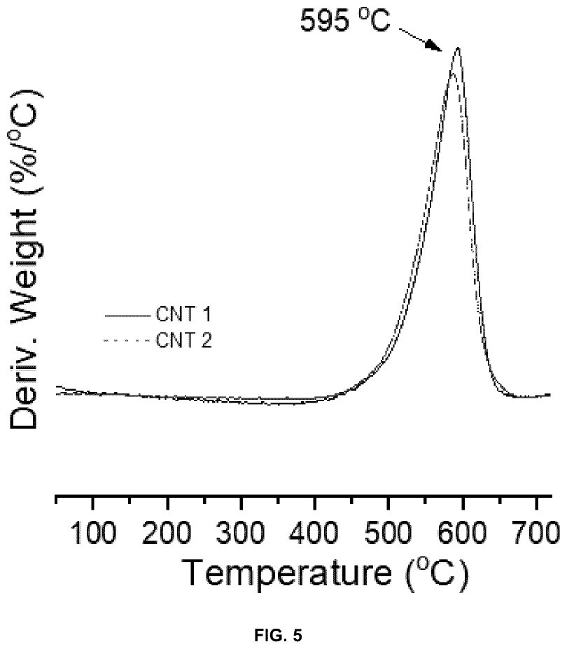

Referring now to FIG. 5, thermal gravimetric analysis indicated thermal decomposition temperature of CNTs (CNT1 from 15 wt % FeNi_{trace}/Al₂O₃ (Fe/Ni=105) and CNT2 from 10 wt % FeNi_{trace}/Al₂O₃ (Fe/Ni=105)) is at about 595° C., indicating well crystallized CNTs with high graphitization.

In a CO₂ dry reforming of plastic waste to CNT process, the catalyst is firstly reduced at temperatures ranging from 600° C.-800° C., more preferably 700° C.-800° C., for 10-30 mins. Pyrolysis of waste plastic was then performed at a temperature from 450° C.-600° C. with fast ramping of 30° C./min to 60° C./min. CO₂ was introduced into the catalytic chamber when waste plastic started to decompose and the reaction took about 5-10 mins in total. Gas streams were monitored using online-MS and analysed with online-GC. A summary of the preliminary results using different type of catalysts is shown in Table 2 below, in comparison with catalysts reported in literature.

TABLE 2
Performance of the catalysts in CO2 dry
reforming of waste plastic to syngas

| | WP | H₂ | CH₄ | CO | C₂—C₄ | CO₂ |
|---|---|---|---|---|---|---|
| Catalyst | g | vol % | vol % | vol % | vol % | vol % |
| 15 wt % FeNi_{trace}/Al₂O₃ | 1 | 77 | 6 | 17 | 0.2 | 0 |
| (Fe/Ni = 105) | | | | | | |
| 15 wt % Fe/Al₂O₃ | 1 | 73 | 5.7 | 18 | 1.0 | 2 |
| 15 wt % Ni/Al₂O₃ | 1 | 27 | 15 | 13 | 11 | 33 |
| 20 wt % NiCo_{0.5}/Al2O3 | 1 | 70.5 | 3.5 | 26 | 0 | 0 |
| (co-ppt)^{Ref2} | | | | | | |
| 20 wt % NiCo₂/Al2O3 | 1 | 75.5 | 3.3 | 21.2 | 0.01 | 0 |
| (co-ppt)^{Ref2} | | | | | | |
| 20 wt % Ni/Al2O3 | 1 | 74.1 | 4.0 | 21.9 | 0 | 0 |
| (co-ppt)^{Ref2} | | | | | | |
| 20 wt % NiCo_{0.5}/Al2O3 | 1 | 55.8 | 7.9 | 22.5 | 4.5 | 9.3 |
| (impregnation)^{Ref2} | | | | | | |
| 20 wt % NiCo₂/Al2O3 | 1 | 58.8 | 5.7 | 20.8 | 3.5 | 11.2 |
| (impregnation)^{Ref2} | | | | | | |

^{Ref2}Fuel Processing Technology 138 (2015) 156-163; Waste Management 58 (2016) 214-220

As can be seen from Table 2 above, the same single metal oxide catalysts were found to be efficient in CO₂ dry reforming of waste plastic into H₂-enriched syngas. Under the same operating conditions, the H₂ and CO production with the catalysts formed by the catalytic plastic conversion method 50 was around 80-85 vol % and 10-15 vol %, respectively, with minimal presence of other hydrocarbon gases. In comparison, the best reported bimetallic catalyst 20 wt % NiCo₂/Al₂O₃ from the literature produced 70-75 vol % H₂ with 21-26 vol % CO.

As is evident from the foregoing discussion, the present invention provides a cost-effective and efficient single metal oxide catalyst on various supports for thermal catalytic conversion of waste plastic. The present invention also provides a method to synthesize cheap single metal oxide supported catalysts that are highly efficient in converting waste plastic to high value products (e.g., CNTs, H₂). The present invention further provides cost effective and energy efficient catalytic processes with highly efficient in-house developed catalysts for catalytic conversion of waste plastic into 1) high quality carbon nanotubes (CNTs) with H₂ as by-product, and 2) H₂-enriched syngas. The cheap and effective single metal oxide catalysts of the present invention may be used to convert polyolefin-enriched waste plastics (e.g., PE, PET, PP, PS, household plastic wastes) through relatively low temperature (less than 700° C.) thermal catalytic processes to (1) carbon nanotubes (CNTs) and H₂, and (2) H₂-enriched syngas, through two different catalytic pathways with one convertible reactor system. The cost effective and efficient single metal oxide catalysts on various supports of the present invention may be used to produce high quality CNTs from waste plastic, with 75 wt % of the carbon upcycled to be CNT from the waste plastic, at a relatively low process temperature of about 700° C. (compared to the temperature range of 1000° C. to 1200° C. in conventional methods of producing CNTs). High yield of CNTs (approximately 70-75% of C recovery from the waste plastics) is produced from solely waste plastic and/or household waste plastic mixture without the use of H₂ through the described pyrolysis-catalytic process over iron-based single metal oxide catalysts, with a gas stream containing primarily H₂ (approximately 85%). Through another catalytic pathway, H₂-enriched syngas is produced by CO₂ drying reforming of plastic with iron-based single metal oxide catalysts, with CO₂ and waste plastic as the only feedstocks. The present invention may be used for pyrolysis alone and/or catalytic-pyrolysis of any waste materials containing high carbon content to produce CNTs, H₂ or syngas.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A catalyst, comprising:
a single metal oxide on a catalyst support.

2. The catalyst according to claim 1, wherein the catalyst support is loaded with between about 5 percent by weight (wt %) and about 15 wt % of the single metal oxide.

3. The catalyst according to claim 1 or 2, further comprising a trace amount of a secondary metal oxide on the catalyst support.

4. The catalyst according to claim 3, wherein the secondary metal oxide forms metal clusters with the single metal oxide.

5. The catalyst according to claim 3 or 4, wherein a molar ratio of the single metal oxide to the secondary metal oxide is between about 50 and about 1050.

6. The catalyst according to claim 5, wherein the molar ratio of the single metal oxide to the secondary metal oxide is between about 105 and about 210.

7. The catalyst according to any one of the preceding claims, wherein the catalyst support is one of alumina (Al₂O₃), silica (SiO₂) and Al₂O₃MgO.

8. A catalyst synthesis method, comprising:
dissolving a single metal precursor in deionised water to form a precursor-containing solution;
mixing a catalyst support into the precursor-containing solution to impregnate the catalyst support with the precursor-containing solution;
drying the impregnated catalyst support; and
calcining the dried impregnated catalyst support to form a supported single metal oxide catalyst.

9. The catalyst synthesis method according to claim 8, wherein the single metal precursor is one of iron (III) nitrate nonahydrate, iron chloride, iron carbonate, iron acetate, nickel chloride, nickel carbonate, nickel acetate and nickel (II) nitrate hexahydrate.

10. The catalyst synthesis method according to claim 8 or 9, wherein the catalyst support is one of alumina (Al₂O₃), silica (SiO₂) and Al₂O₃MgO.

11. The catalyst synthesis method according to any one of claims 8 to 10, further comprising adding a trace amount of a secondary metal precursor to the precursor-containing solution before mixing the catalyst support into the precursor-containing solution.

12. The catalyst synthesis method according to claim 11, wherein the secondary metal precursor is one of nickel (II) nitrate hexahydrate, nickel chloride, nickel carbonate and nickel acetate.

13. The catalyst synthesis method according to claim 11 or 12, wherein a molar ratio of metal content in the single metal precursor to the secondary metal precursor is between about 50 and about 1050.

14. The catalyst synthesis method according to claim 13, wherein the molar ratio of the metal content in the single metal precursor to the secondary metal precursor is between about 105 and about 210.

15. The catalyst synthesis method according to any one of claims 8 to 14, wherein the dried impregnated catalyst support is calcined at a temperature of between about 200 degrees Celsius (° C.) and about 800° C.

16. The catalyst synthesis method according to claim 15, wherein the dried impregnated catalyst support is calcined at 500° C.

17. A catalytic plastic conversion method, comprising:
providing the catalyst of any one of claims 1 to 7;
providing a quantity of plastic; and
performing catalytic-pyrolysis of the plastic using the catalyst.

18. The catalytic plastic conversion method according to claim 17, further comprising reducing the catalyst before performing catalytic-pyrolysis of the plastic using the reduced catalyst.

19. The catalytic plastic conversion method according to claim 18, wherein the catalyst is reduced at a temperature of between about 600° C. and about 800° C.

20. The catalytic plastic conversion method according to claim 18 or 19, wherein the catalyst is reduced for a period of between about 10 minutes (min) and about 30 min.

21. The catalytic plastic conversion method according to any one of claims 17 to 20, wherein catalytic-pyrolysis of the plastic is performed at a temperature of less than 700° C.

22. The catalytic plastic conversion method according to claim 21, wherein the temperature at which catalytic-pyrolysis of the plastic is performed is between about 450° C. and about 600° C.

23. The catalytic plastic conversion method according to any one of claims 17 to 22, wherein catalytic-pyrolysis of the plastic is performed at a ramp rate of between about 30 degrees Celsius per minute (° C./min) and about 60° C./min.

24. The catalytic plastic conversion method according to any one of claims 17 to 23, wherein catalytic-pyrolysis of the plastic is performed at ambient pressure.

25. The catalytic plastic conversion method according to any one of claims 17 to 24, wherein catalytic-pyrolysis of the plastic is performed for a period of between about 5 min and about 10 min.

26. The catalytic plastic conversion method according to any one of claims 17 to 25, wherein the plastic comprises one or more of polyethylene (PE), polyethylene terephthalate (PET), polystyrene (PS), household plastic waste and polypropylene (PP).

27. The catalytic plastic conversion method according to any one of claims 17 to 26, further comprising generating a plurality of carbon nanotubes from catalytic-pyrolysis of the plastic.

28. The catalytic plastic conversion method according to claim 27, wherein a yield of the carbon nanotubes from catalytic-pyrolysis of the plastic is between about 28 percent by mass (wt %) and about 84 wt % of carbon content in the plastic.

29. The catalytic plastic conversion method according to claim 28, wherein the yield of the carbon nanotubes from catalytic-pyrolysis of the plastic is between about 70 wt % and about 75 wt % of carbon content in the plastic.

30. The catalytic plastic conversion method according to any one of claims 27 to 29, further comprising generating hydrogen gas from catalytic-pyrolysis of the plastic.

31. The catalytic plastic conversion method according to claim 30, further comprising generating methane gas from catalytic-pyrolysis of the plastic.

32. The catalytic plastic conversion method according to claim 31, wherein the hydrogen gas comprises between about 77 percent by volume (vol %) and about 88 vol % of a gas stream from catalytic-pyrolysis of the plastic.

33. The catalytic plastic conversion method according to claim 32, wherein the methane gas comprises between about 6 vol % and about 18 vol % of the gas stream from catalytic-pyrolysis of the plastic.

34. The catalytic plastic conversion method according to any one of claims 17 to 26, further comprising introducing carbon dioxide (CO₂) when the plastic starts to decompose.

35. The catalytic plastic conversion method according to claim 34, further comprising generating synthesis gas from CO₂ reforming of the plastic.

36. The catalytic plastic conversion method according to claim 35, wherein the synthesis gas comprises between about 27 vol % and about 85 vol % of hydrogen gas.

37. The catalytic plastic conversion method according to claim 36, wherein the synthesis gas comprises between about 80 vol % and about 85 vol % of hydrogen gas.

38. The catalytic plastic conversion method according to claim 36 or 37, wherein the synthesis gas comprises between about 10 vol % and about 18 vol % of carbon monoxide gas.

39. The catalytic plastic conversion method according to claim 38, wherein the synthesis gas comprises between about 10 vol % and about 15 vol % of carbon monoxide gas.
